(19) United States
(12) Patent Application Publication
(10) Pub. No.: US 2022/0263129 A1
(43) Pub. Date: Aug. 18, 2022

(54) NON-FLAMMABLE SOLVATE IONIC LIQUID ELECTROLYTE WITH DILUTERS

(71) Applicant: GM GLOBAL TECHNOLOGY OPERATIONS LLC, Detroit, MI (US)

(72) Inventors: Yong LU, Shanghai (CN); Zhe LI, Shanghai (CN); Qili SU, Shanghai (CN)

(73) Assignee: GM GLOBAL TECHNOLOGY OPERATIONS LLC, Detroit, MI (US)

(21) Appl. No.: 17/556,175

(22) Filed: Dec. 20, 2021

(30) Foreign Application Priority Data
Feb. 17, 2021 (CN) 202110186274.4

(51) Int. Cl. H01M 10/0565; H01M 10/0568; H01M 10/0569; H01M 10/0567; H01M 10/0525

(52) U.S. Cl. CPC H01M 10/0565; H01M 10/0568; H01M 2250/20; H01M 10/0567; H01M 10/0525; H01M 10/0569

(57) ABSTRACT

An electrolyte composition is provided. The electrolyte composition includes a solvate ionic liquid having an anion and a complex of an ether and a cation, and a diluter including a phosphorus-containing flame-retardant having a dielectric constant of less than or equal to about 20.

### CROSS-REFERENCE TO RELATED APPLICATIONS

This application claims the benefit and priority of Chinese Application No. 202110186274.4, filed Feb. 17, 2021. The entire disclosure of the above application is incorporated herein by reference.

### INTRODUCTION

This section provides background information related to the present disclosure which is not necessarily prior art.

High-energy density electrochemical cells, such as lithium ion batteries, can be used in a variety of consumer products and vehicles, such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes, a separator, and an electrolyte. Lithium-ion batteries may also include various terminal and packaging materials. One of the two electrodes serves as a positive electrode (i.e., a cathode), and the other electrode serves as a negative electrode (i.e., an anode). Many rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes.

The electrolyte is suitable for conducting lithium ions (or sodium ions in the case of sodium-ion batteries) between the electrodes and may be in a solid form, a liquid form, or a solid-liquid hybrid form. In the instances of solid-state batteries, which include a solid-state electrolyte layer disposed between solid-state electrodes, the solid-state electrolyte layer physically separates the electrodes so that a distinct separator is not required. It is beneficial for electrolytes to have a high ionic conductivity, thermal and long-term cycling stability, and low flammability. The following disclosure is directed to such an electrolyte.

### SUMMARY

This section provides a general summary of the disclosure, and is not a comprehensive disclosure of its full scope or all of its features.

The present disclosure relates to non-flammable solvate ionic liquid electrolytes with diluters. In various aspects, the current technology provides an electrolyte composition including a solvate ionic liquid having an anion and a complex of an ether and a cation, and a diluter including a phosphorus-containing flame-retardant having a dielectric constant of less than or equal to about 20.

In one aspect, the anion of the solvate ionic liquid is selected from the group consisting of bis(trifluoromethanesulfonyl)imide (TFSI⁻), bis(pentafluoroethanesulfonyl)imide (BETI⁻), hexafluorophosphate (PF₆⁻), tetrafluoroborate (BF₄⁻), trifluoromethyl sulfonate (TfO⁻), difluoroborate (DFOB⁻), bis(oxalate)borate (BOB⁻), and a combination thereof.

In one aspect, the ether is an oligoether having the formula CH₃O—(CH₂CH₂O)ₙ—CH₃, where 1≤n≤10 and the cation is Li⁺.

In one aspect, the diluter includes a phosphate flame-retardant selected from the group consisting of triethyl phosphate, trimethyl phosphate, tributyl phosphate, triphenyl phosphate, phosphazene, diphenyloctyl phosphate, tris(2, 2, 2-trifluoroethyl)phosphate, and a combination thereof.

In one aspect, the diluter includes a phosphite flame-retardant selected from the group consisting of triethyl phosphite, trimethyl phosphite, tributyl phosphite, triphenyl phosphite, and a combination thereof.

In one aspect, the diluter includes a phosphonate flame-retardant selected from the group consisting of bis(2.2.2.-trifluoroethyl) methyl phosphonate, diethyl phosphonate, diethyl ethyl phosphonate, and a combination thereof.

In one aspect, the solvate ionic liquid and the diluter are present in a solvate ionic liquid:diluter ratio of from about 1:10 to about 5:1 by volume.

In one aspect, the solvate ionic liquid includes an anion:complex molar ratio of about 1:1.

In one aspect, the electrolyte composition further includes a solid electrolyte interface additive.

In one aspect, the electrolyte composition is substantially free of solvents that are not ionic liquids or solvate ionic liquids.

In one aspect, the solvate ionic liquid and diluter are embedded within a polymer, the polymer having a concentration of greater than 0 wt. % to less than or equal to about 50 wt. % based on the total weight of the solvate ionic liquid and the polymer, and wherein the electrolyte composition is a gel electrolyte.

In various aspects, the current technology also provides an electrochemical cell including the electrolyte composition.

In various aspects, the current technology further provides an electrochemical cell including a positive electrode including positive electroactive particles; a negative electrode including negative electroactive particles; and an electrolyte composition including a solvate ionic liquid having an anion and a glyme-lithium cation complex in an anion:glyme-lithium cation complex molar ratio of about 1:1, and a diluter including a phosphorus-containing flame-retardant having a dielectric constant of less than or equal to about 20, wherein the solvate ionic liquid and the diluter are present in a solvate ionic liquid:diluter volumetric ratio of from about 1:10 to about 5:1, and wherein the electrolyte composition is non-flammable, and wherein the electrochemical cell exhibits a capacity retention of greater than or equal to about 95% after 100 cycles of charging and discharging.

In one aspect, the anion of the solvate ionic liquid is bis(trifluoromethanesulfonyl)imide (TFSI⁻), bis(pentafluoroethanesulfonyl)imide (BETI⁻), hexafluorophosphate (PF₆⁻), tetrafluoroborate (BF₄⁻), trifluoromethyl sulfonate (TfO⁻), difluoroborate (DFOB⁻), bis(oxalate)borate (BOB⁻), or a combination thereof, and the glyme of the solvate ionic liquid is ethylene glycol dimethyl ether (G1), diethylene glycol dimethyl ether (G2), triethylene glycol dimethyl ether (G3), tetraethylene glycol dimethyl ether (G4), or a combination thereof.

In one aspect, the anion is bis(trifluoromethanesulfonyl)imide (TFSI⁻), the glyme includes at least one of triethylene glycol dimethyl ether (G3) or tetraethylene glycol dimethyl ether (G4), and the diluter includes triethyl phosphate.

In one aspect, the electrochemical cell further includes a polymeric separator disposed between the positive electrode and the negative electrode, wherein the electrolyte composition is capable of transporting lithium ions between the positive electrode and the negative electrode, and wherein the electrolyte composition is a liquid or a gel including the solvate ionic liquid and the diluter embedded within a polymer matrix.

In one aspect, the electrochemical cell is a solid-state electrochemical cell further including a solid-state electrolyte disposed between the positive electrode and the negative electrode, wherein the electrolyte composition is in contact with at least a portion of the positive electroactive particles, the negative electroactive particles, the solid-state electrolyte, or a combination thereof, and wherein the electrolyte composition is a liquid or a gel including the solvate ionic liquid and the diluter embedded within a polymer matrix.

In various aspects, the current technology yet further provides a method of fabricating an electrochemical cell, the method including contacting an electrolyte composition to at least one of a positive electrode, a negative electrode, or one of a polymeric separator or a solid-state electrolyte, wherein the electrolyte composition includes a solvate ionic liquid having an anion and a complex of an ether and a cation, and a diluter including a phosphorus-containing flame-retardant having a dielectric constant of less than or equal to about 20.

In one aspect, the electrolyte composition is a liquid or a gel including the solvate ionic liquid and the diluter embedded within a polymer matrix.

In one aspect, the anion of the solvate ionic liquid is bis(trifluoromethanesulfonyl)imide (TFSI⁻), bis(pentafluoroethanesulfonyl)imide (BETI⁻), hexafluorophosphate (PF₆⁻), tetrafluoroborate (BF₄⁻), trifluoromethyl sulfonate (TfO⁻), difluoroborate (DFOB⁻), bis(oxalate)borate (BOB⁻), or a combination thereof; the glyme of the solvate ionic liquid is ethylene glycol dimethyl ether (G1), diethylene glycol dimethyl ether (G2), triethylene glycol dimethyl ether (G3), tetraethylene glycol dimethyl ether (G4), or a combination thereof; and the cation is lithium cation

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of a first electrochemical cell in accordance with various aspects of the current technology.

FIG. 2 is an illustration of a second electrochemical cell in accordance with various aspects of the current technology.

FIG. 3 is an illustration of a third electrochemical cell in accordance with various aspects of the current technology.

FIG. 4 is an illustration of an electrolyte composition including a solvate ionic liquid and a diluter in accordance with various aspects of the current technology.

FIG. 5 shows complexes of various glymes with a lithium cation in accordance with various aspects of the current technology.

FIG. 6 is an illustration of an electrolyte composition including a solvate ionic liquid and a diluter embedded within a polymer matrix in accordance with various aspects of the current technology.

FIG. 7 is a photograph of a gel membrane electrolyte composition including a solvate ionic liquid and a diluter embedded within a polymer matrix in accordance with various aspects of the current technology.

FIGS. 8A-8C. FIGS. 8A, 8B, and 8C are illustrations of a negative electroactive particle, a positive electroactive particle, and a solid-state electrolyte particle, respectively, each coated with a gel electrolyte composition including a solvate ionic liquid and a diluter embedded within a polymer matrix in accordance with various aspects of the current technology.

FIG. 9 is a graph showing a cycling capability of an exemplary electrolyte composition in accordance with various aspects of the current technology and a variety of comparative electrolytes.

FIG. 10 is a Nyquist plot showing the impedance of exemplary electrolyte compositions in accordance with various aspects of the current technology.

FIGS. 11A-11C. FIGS. 11A, 11B, and 11C show an exemplary electrolyte composition in accordance with various aspects of the current technology before, during, and after contact with a flame, respectively.

FIG. 12 is a graph showing rate capabilities of exemplary electrolyte compositions in accordance with various aspects of the current technology.

FIG. 13 is a graph showing cycling performance of exemplary electrolyte compositions in accordance with various aspects of the current technology.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology provides electrolyte compositions having a solvate ionic liquid. A fire-retardant diluter is included in the electrolyte compositions to decrease viscosity and enhance ionic conductivity without sacrificing electrochemical stability, and to improve cyclability. The electrolyte compositions are non-flammable and suitable for high power applications.

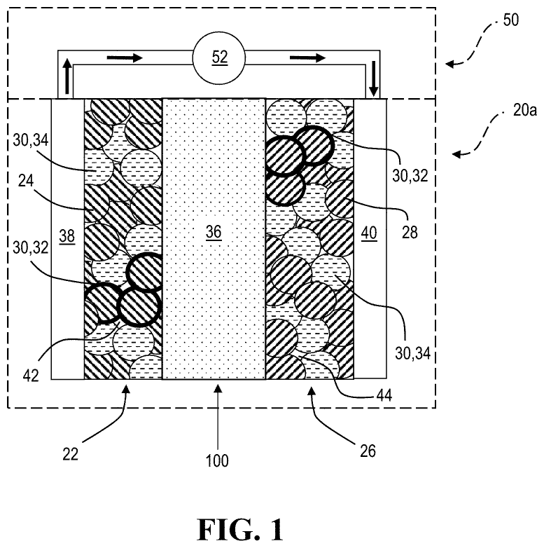

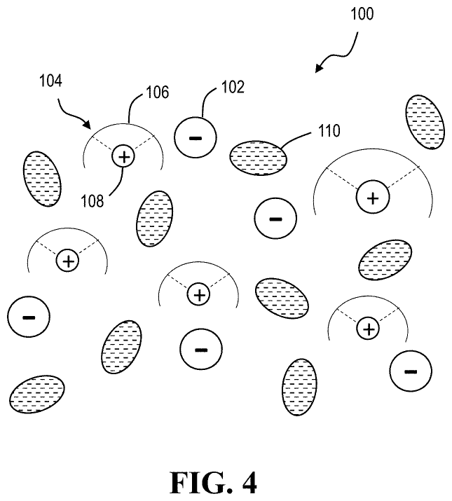

An exemplary and schematic illustration of an electrochemical cell 20a (also referred to herein as “the battery”), i.e., a lithium-ion cell, that cycles lithium ions is shown in FIG. 1. Unless specifically indicated otherwise, the term “ions” as used herein refers to lithium ions. The battery 20a includes a negative electrode 22 (i.e., an anode) comprising a plurality of negative electroactive particles 24, and a positive electrode 26 (i.e., a cathode) comprising a plurality of positive electroactive particles 28. One or both of the negative electrode 22 or the positive electrode 26 may also include an adjunct electrolyte 30 that is directly associated with, including embedded or dispersed within, the negative and/or positive electroactive particles 24,28. When associated with the negative electroactive particles 24 of the negative electrode 22, the adjunct electrolyte 30 may be referred to as an “anolyte.” When associated with the positive electroactive particles 28 of the positive electrode 26, the adjunct electrolyte 30 may be referred to as a “catholyte.” The adjunct electrolyte 30 can be a liquid or gel electrolyte 32 comprising an electrolyte composition 100, discussed in more detail below with reference to FIG. 4, and/or the adjunct electrolyte 30 can include a plurality of solid-state electrolyte particles 34. In some aspects, the negative and positive electrodes 22,26 can include the same adjunct electrolyte 30, and in other aspects, the negative and positive electrodes 22, 26 can include different adjunct electrolytes 30. When present, the adjunct electrolyte 30 can be at least one of: (1) the liquid or gel adjunct electrolyte 30,32 dispersed between or coating the negative electroactive particles 24 and/or the positive electroactive particles 28; or (2) the solid-state adjunct electrolyte 30,34 dispersed between the negative electroactive particles 24 and/or the positive electroactive particles 28. The battery 20a also includes a separator 36 disposed between the electrodes 22,26. The separator 36 operates as an electrical insulator by being sandwiched between the negative electrode 22 and the positive electrode 26 to prevent physical contact and, thus, the occurrence of a short circuit. The electrolyte composition 100 is present throughout the separator 36 as a liquid electrolyte or a gel electrolyte and, optionally, in the negative electrode 22 and/or in the positive electrode 26 as the adjunct electrolyte 30,32. When present, the adjunct electrolyte 30 helps to provide a continuous electrolyte network between electrodes 22,26. In addition to providing a physical barrier between the electrodes 22,26, the separator 36 acts like a sponge that contains the electrolyte composition 100 in a network of open pores during the cycling of lithium ions to facilitate functioning of the secondary battery 20. During discharge, a chemical potential difference between the positive electrode 26 and the negative electrode 22 drives electrons produced by the oxidation of intercalated lithium at the negative electrode 22 through the external circuit 50 (as shown by the block arrows) toward the positive electrode 26. Lithium ions, which are also produced at the negative electrode 22, are concurrently transferred through the electrolyte composition 100 contained in the separator 36 towards the positive electrode 26.

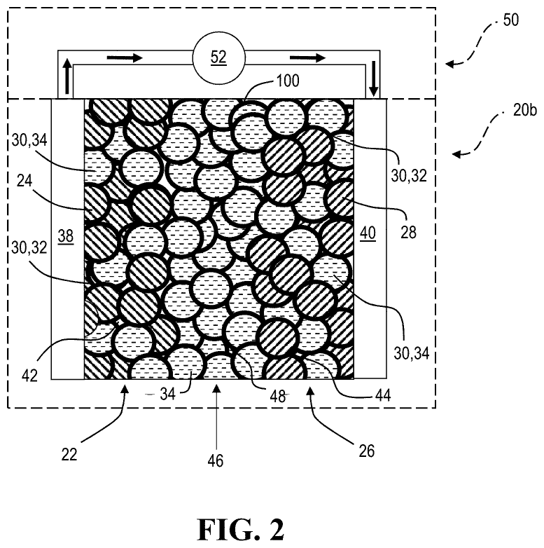

The solid-state electrolyte particles 34 of the adjunct electrolyte 30, or that define a solid-state electrolyte 46 of a solid-state battery 20b as discussed below with reference to FIG. 2, can be oxide-based (and optionally metal-doped), sulfide-based, nitride-based, hydride-based, halide-based, or borate-based. The oxide-based particles include garnet-type oxides, perovskite-type oxides, sodium super ionic conductor (NASICON)-type oxides, lithium super ionic conductor (LISICON)-type oxides, and doped-derivatives thereof, and combinations thereof. The garnet-type oxides can have the base formula Li₇La₃Zr₂O₁₂ (LLZO) and a tetrahedral structure. The perovsike-type oxides can have the base formula Li₃ₓLa_{2/3-x}TiO₃, where 0<x<3 (LLTO). The NASICON-type oxides can have the base formula Li₁₊ₓAlₓTi₂₋ₓ(PO₄)₃, (LATP, e.g., Li_{1.3}Al_{0.3}Ti_{1.7}(PO₄)₃ and Li_{1.4}Al_{0.4}Ti_{1.6}(PO₄)₃) or Li₁₊ₓ AlₓGe₂₋ₓ(PO₄)₃ (LAGP). The LISICON-type oxides can have the formula Li₂₊₂ₓZn₁₋ₓ GeO₄ (LZGO). Doped-derivatives of the oxide-based solid-state electrolytes can have a higher ionic conductivity relative to corresponding un-doped base structures. As non-limiting examples, the dopant comprises aluminum (Al³⁺, from, for example, Al₂O₃), tantalum (Ta⁵⁺, from, for example, TaCl₅), niobium (Nb⁵⁺, from, for example, Nb(OCH₂CH₃)₅), gallium (Ga³⁺, from, for example, Ga₂O₃), indium (In³⁺, from, for example, In₂O₃), tin (Sn⁴⁺, from, for example, SnO₄), antimony (Sb⁴⁺, from, for example, Sb₂O₃), bismuth (Bi⁴⁺, from, for example, Bi₂O₃), yttrium (Y³⁺, from, for example, Y₂O₃), germanium (Ge⁴⁺, from, for example, GeO₂), zirconium (Zr⁴⁺, from, for example, ZrO₂), calcium (Ca²⁺, from, for example, CaCl), strontium (Sr²⁺, from, for example, SrO), barium (Ba²⁺, from, for example, BaO), hafnium (Hf⁴⁺, from, for example, HfO₂), or combinations thereof. It is understood that the stoichiometry of the base formula of the oxides may change when a dopant is present. For example, doped LLZO can have the formula Li_{7-3x-y}AlₓLa₃Zr_{2-y}M_{y}O₁₂, where M is Ta, and/or Nb; Li_{6.5}La₃Zr_{1.5}M_{0.5}O₁₂, where M is Nb and/or Ta; Li₇₋ₓLa₃Zr₂₋ₓBiₓO₁₂; or Li_{6.5}Ga_{0.2}La_{2.9}Sr_{0.1}Zr₂O₁₂. The sulfide-based solid-state electrolytes can include a Li₂S—P₂S₅ system, a Li₂S—P₂S₅-MO_{X} system, a Li₂S—P₂S₅-MSₓ system, Li₁₀GeP₂S₁₂, (LGPS), thio-LISICON (Li_{3.25}Ge_{0.25}P_{0.75}S₄), Li_{3.4}Si_{0.4}P_{0.6}S₄, Li₁₀GeP₂S_{11.7}O_{0.3}, lithium argyrodite Li₆PS₅X (X═Cl, Br, or I), Li_{9.54}Si_{1.74}P_{1.44}S_{11.7}Cl_{0.3} (25 mS/cm), Li_{9.6}P₃S₁₂, Li₇P₃S₁₁, Li₉P₃S₉O₃, Li_{10.35}Ge_{1.35}P_{1.65}S₁₂, Li_{0.35}Si_{1.35}P_{1.65}S₁₂, Li_{9.81}Sn_{0.81}P_{2.19}S₁₂, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.166}S₄, LiI—Li₄SnS₄, Li₄SnS₄, and combinations thereof. Exemplary nitride-based solid-state electrolytes include Li₃N, Li₇PN₄, LiSi₂N₃, Li₂PO₂N (LIPON), and combinations thereof. Exemplary hydride-based solid-state electrolytes include LiBH₄, LiBH₄—LiX (X═Cl, Br or I), LiNH₂, Li₂NH, LiBH₄—LiNH₂, Li₃AlH₆, and combinations thereof. Exemplary halide-based solid-state electrolytes include LiI, Li₃InCl₆, Li₂CdCl₄, Li₂MgCl₄, Li₂CdI₄, Li₂ZnI₄, Li₃OCl, and combinations thereof. Exemplary borate-based solid-state electrolytes include Li₂B₄O₇, Li₂O—B₂O₃—P₂O₅, and combinations thereof.

A negative electrode current collector 38 may be positioned at or near the negative electrode 22, and a positive electrode current collector 40 may be positioned at or near the positive electrode 26. The negative electrode current collector 38 and the positive electrode current collector 40 respectively collect and move free electrons to and from an external circuit 50 (as shown by the block arrows). For example, an interruptible external circuit 50 and a load device 52 may connect the negative electrode 22 (through the negative electrode current collector 38) and the positive electrode 26 (through the positive electrode current collector 40). Composite electrodes can also include an electrically conductive material, such as carbon black or carbon nanotubes, that is dispersed throughout materials that define the negative electrode 22 and/or the positive electrode 26.

The battery 20a can generate an electric flow (indicated by the block arrows) during discharge by way of reversible electrochemical reactions that occur when the external circuit 50 is closed (to connect the negative electrode 22 and the positive electrode 26) and when the negative electrode 22 contains a relatively greater quantity of lithium. The chemical potential difference between the negative electrode 22 and the positive electrode 26 drives electrons produced by the oxidation of inserted lithium at the negative electrode 22 through the external circuit 50 towards the positive electrode 26. Ions, which are also produced at the negative electrode 22, are concurrently transferred through the electrolyte composition 100 towards the positive electrode 26. The electrons flow through the external circuit 50, and the ions migrate through the electrolyte composition 100 and across the separator 36 to the positive electrode 26, where they may be plated, reacted, or intercalated. The electric current passing through the external circuit 50 can be harnessed and directed through the load device 52 (in the direction of the block arrows) until the lithium in the negative electrode 22 is depleted and the capacity of the battery 20a is diminished.

The battery 20a can be charged or reenergized at any time by connecting an external power source (e.g., charging device) to the battery 20a to reverse the electrochemical reactions that occur during battery discharge. The connection of the external power source to the battery 20a compels the non-spontaneous oxidation of one or more metal elements at the positive electrode 26 to produce electrons and ions. The electrons, which flow back towards the negative electrode 22 through the external circuit 50, and the ions, which move across the separator 36 back towards the negative electrode 22, reunite at the negative electrode 22 and replenish it with lithium for consumption during the next battery discharge cycle. As such, each discharge and charge event is considered to be a cycle, where ions are cycled between the positive electrode 26 and the negative electrode 22.

The external power source that may be used to charge the battery 20a may vary depending on size, construction, and particular end-use of the battery 20. Some notable and exemplary external power sources include, but are not limited to, AC power sources, such as AC wall outlets and motor vehicle alternators, which may require an AC:DC converter. In many of the configurations of the battery 20, each of the negative electrode current collector 38, the negative electrode 22, the separator 36, the positive electrode 26, and the positive electrode current collector 40 are prepared as relatively thin layers (for example, from several microns to a millimeter or less in thickness) and assembled in layers connected in electrical parallel arrangement to provide a suitable electrical energy and power package. In various other instances, the battery 20a may include electrodes 22, 26 connected in series.

Further, in certain aspects, the battery 20a may include a variety of other components that, while not depicted here, are nonetheless known to those of skill in the art. For instance, the battery 20a may include a casing, a gasket, terminal caps, and any other conventional components or materials that may be situated within the battery 20a, including between or around the negative electrode 22, the positive electrode 26, and/or the separator 36, by way of non-limiting example. As noted above, the size and shape of the battery 20a may vary depending on the particular applications for which it is designed. Battery-powered vehicles and hand-held consumer electronic devices are two examples where the battery 20a would most likely be designed to different size, capacity, and power-output specifications. The battery 20a may also be connected in series or parallel with other similar lithium-ion cells or batteries to produce a greater voltage output, energy, and power if it is required by the load device 52.

Accordingly, the battery 20a can generate an electric current to the load device 52 that can be operatively connected to the external circuit 50. The load device 52 may be fully or partially powered by the electric current passing through the external circuit 40 when the battery 20a is discharging. While the load device 52 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 52 may also be a power-generating apparatus that charges the battery 20a for purposes of storing energy.

The separator 36 operates as both an electrical insulator and a mechanical support. In one embodiment, the separator 36 is a microporous polymer comprising a polyolefin. The polyolefin may be a homopolymer (derived from a single monomer constituent) or a heteropolymer (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer.

When the separator 36 is a microporous polymeric separator, it has a thickness of greater than or equal to about 1 μm to less than or equal to about 100 μm or greater than or equal to about 1 μm to less than or equal to about 50 μm. The microporous polymeric separator may be a single layer or a multi-layer laminate, which may be fabricated from either a dry or wet process. For example, in one embodiment, a single layer of the polyolefin may form the entire microporous polymeric separator 36. In other aspects, the separator 36 may be a fibrous membrane having an abundance of pores extending between the opposing surfaces and may have a thickness of less than a millimeter, for example. As another example, multiple discrete layers of similar or dissimilar polyolefins may be assembled to form the microporous polymeric separator 36. The polyolefins may be homopolymers (derived from a single monomer constituent) or heteropolymers (derived from more than one monomer constituent), which may be either linear or branched. If a heteropolymer is derived from two monomer constituents, the polyolefin may assume any copolymer chain arrangement, including those of a block copolymer or a random copolymer. Similarly, if the polyolefin is a heteropolymer derived from more than two monomer constituents, it may likewise be a block copolymer or a random copolymer. In certain aspects, the polyolefin may be polyacrylonitrile (PAN), polyvinylidene fluoride (PVDF), polyvinylidene fluoride-hexafluoropropylene (PVDF-HFP, optionally reinforced with expanded PTFE), polyethylene (PE; optionally coated with, e.g., SiO₂), polyethylene oxide (PEO), polypropylene (PP), polypropylene oxide (PPO), a blend of PE and PP, multi-layered structured porous films of PE and/or PP, and copolymers thereof. The microporous polymeric separator 38 may also comprise other polymers in addition to, or alternative to, the polyolefin, such as, but not limited to, polyacrylonitirle (PAN), polymethacrylonitrile (PMAN), polymethyl methacrylate (PMMA), polyethylene terephthalate (PET) and/or a polyamide. Commercially available polyolefin porous membranes include CELGARD® 2400 and 2500 (monolayer polypropylene separators), CELGARD® 2730 (a monolayer polyethylene separator), and CELGARD® 2010, 2320, and 2325 (trilayer polypropylene/polyethylene/polypropylene separators), all available from Celgard, LLC, polyimide (PI) nanofiber-based nonwovens, nano-sized Al₂O₃ and poly(lithium 4-styrenesulfonate)-coated polyethylene membrane, co-polyimide-coated polyethylene, polyetherimides (PEI), bisphenol-aceton diphthalic anhydride (BPADA), para-phenylenediamine, sandwich-structured PVdF/PMIA/PVdF nanofibrous separators, and the like. The polyolefin layer and any other optional polymer layers may further be included in the microporous polymeric separator 36 as a fibrous layer to help provide the microporous polymeric separator 36 with appropriate structural and porosity characteristics. Various conventionally available polymers and commercial products for forming the separator 36 are contemplated. The many manufacturing methods that may be employed to produce such microporous polymeric separators 36 are also contemplated.

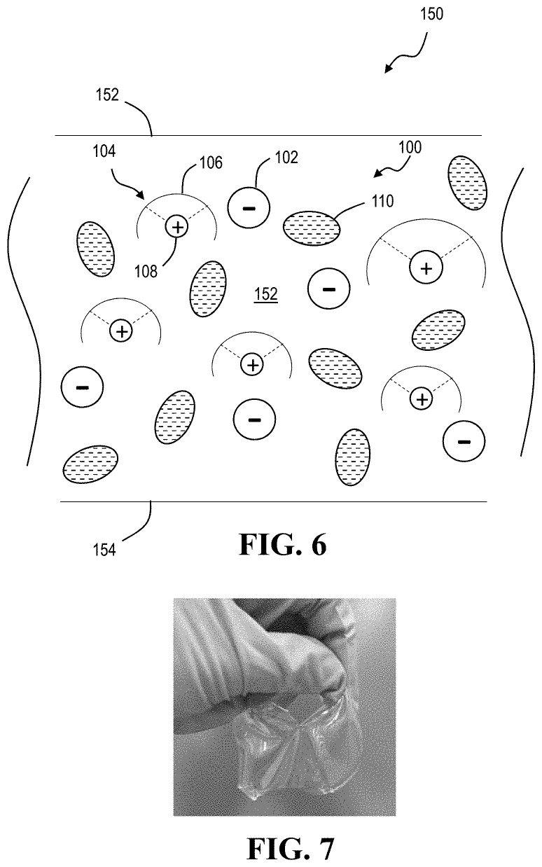

When a polymer, the separator 36 may be mixed with the electrolyte composition 100 and/or a ceramic material or its surface may be coated with the electrolyte composition 100 or a ceramic material. For example, a ceramic coating may include ceramic oxides such as alumina (Al₂O₃), zirconium oxide (ZrO₂), silicon dioxide (SiO₂), titania (TiO₂), LLZO, LLTO, LATP, LISICON, LIPON, or combinations thereof. In various alternative embodiments, instead of a polymeric material as discussed above, the separator 36 comprises a green ceramic oxide (i.e., a ceramic oxide that has not been sintered or otherwise densified) having a high porosity of greater than or equal to about 10 vol. % to less than or equal to about 50 vol. %. When the separator is mixed with the electrolyte composition 100, an electrolyte gel may be formed, such as the electrolyte gel 150 discussed below with reference to FIG. 6.

The negative electrode 22 has a thickness of greater than or equal to about 1 μm to less than or equal to about 1 mm and may be formed from a lithium host material that is capable of functioning as a negative terminal of a lithium-ion battery. For example, in certain variations, the negative electrode 22 may be defined by the negative (solid state) electroactive particles 24. In certain instances, as illustrated, the negative electrode 22 is a composite comprising a mixture of the negative electroactive particles 24 and the adjunct electrolyte 30 (anolyte) as the liquid or gel electrolyte 32 and/or as the plurality of solid-state electrolyte particles 34. For example, the negative electrode 22 may include greater than or equal to about 10 wt. % to less than or equal to about 95 wt. %, and in certain aspects, optionally greater than or equal to about 50 wt. % to less than or equal to about 90 wt. %, of the negative solid-state electroactive particles 24 and greater than 0 wt. % to less than or equal to about 70 wt. %, and in certain aspects, optionally greater than or equal to about 10 wt. % to less than or equal to about 40 wt. %, of the adjunct electrolyte 30. Such negative electrodes 22 may have an interparticle porosity 42 between the negative solid-state electroactive particles 24 and/or the adjunct electrolyte 30 that is greater than or equal to about 0 vol. % to less than or equal to about 20 vol. %. In certain variations, the negative solid-state electroactive particles 24 may be lithium-based, for example, a lithium alloy. In other variations, the negative solid-state electroactive particles 24 may be silicon-based comprising, for example, silicon (Si), SiOₓ, Si/C, SiOₓ/C, or a silicon alloy. In still other variations, the negative electrode 22 may be a carbonaceous anode and the negative solid-state electroactive particles 24 may comprise one or more negative electroactive materials, such as graphite, graphene, carbon nanotubes, hard carbon, soft carbon, and combinations thereof. In still other variations, the negative electrode 22 may be a metal alloy (e.g., Li, Sn, and the like), or a metal oxide (e.g., SnO₂, Fe₃O₄, and the like). In still further variations, the negative electrode 22 may comprise one or more negative electroactive materials, such as lithium titanium oxide (Li₄Ti₅O₁₂); one or more metal oxides, such as V₂O₅; and metal sulfides, such as FeS.

In certain variations, the negative solid-state electroactive particles 24 may be optionally intermingled with one or more electrically conductive materials that provide an electron conduction path and/or at least one polymeric binder material that improves the structural integrity of the negative electrode 22. For example, the negative solid-state electroactive particles 24 may be optionally intermingled with binders, such as bare alginate salts, sodium carboxymethyl cellulose (CMC), polyvinylidene difluoride (PVDF), polytetrafluoroethylene (PTFE), ethylene propylene diene monomer (EPDM) rubber, nitrile butadiene rubber (NBR), styrene-butadiene rubber (SBR), styrene ethylene butylene styrene copolymer (SEBS), styrene butadiene styrene copolymer (SBS), and/or lithium polyacrylate (LiPAA) binders. Electrically conductive materials may include, for example, carbon-based materials or a conductive polymer. Carbon-based materials may include, for example, particles of graphite, graphene, graphene oxide, carbon black (e.g., Super P® carbon black (TIMCAL), acetylene black (such as KETCHEN™ black or DENKA™ black), carbon fibers (e.g., carbon nanofibers), carbon nanotubes, and the like. Examples of a conductive polymer may include polyaniline, polythiophene, polyacetylene, polypyrrole, and the like. In certain variations, conductive additives may include, for example, one or more non-carbon conductive additives selected from simple oxides (such as RuO₂, SnO₂, ZnO, Ge₂O₃), superconductive oxides (such as YBa₂Cu₃O₇, La_{0.75}Ca_{0.25}MnO₃), carbides (such as SiC₂), silicides (such as MoSi₂), and sulfides (such as CoS₂).

In certain aspects, such as when the negative electrode 22 (i.e., anode) does not include lithium metal, mixtures of the conductive materials may be used. For example, the negative electrode 22 may include greater than or equal to about 0 wt. % to less than or equal to about 25 wt. %, optionally greater than or equal to about 0 wt. % to less than or equal to about 10 wt. %, and in certain aspects, optionally greater than or equal to about 0 wt. % to less than or equal to about 5 wt. % of the one or more electrically conductive additives and greater than or equal to about 0 wt. % to less than or equal to about 20 wt. %, optionally greater than or equal to about 0 wt. % to less than or equal to about 10 wt. %, and in certain aspects, optionally greater than or equal to about 0 wt. % to less than or equal to about 5 wt. % of the one or more binders. The negative electrode current collector 38 may be formed from copper or any other appropriate electrically conductive material known to those of skill in the art.

The positive electrode 26 has a thickness that is greater than or equal to about 1 μm to less than or equal to about 1 mm and may be formed from a lithium-based or electroactive material that can undergo lithium intercalation and deintercalation while functioning as the positive terminal of the battery 20. For example, in certain variations, the positive electrode 26 may be defined by the plurality of the positive (solid-state) electroactive particles 28. In certain instances, as illustrated, the positive electrode 26 is a composite comprising a mixture of the positive solid-state electroactive particles 28 and the adjunct electrolyte 30 (catholyte) as the liquid or gel electrolyte 32 and/or as the plurality of solid-state electrolyte particles 34. For example, the positive electrode 26 may include greater than or equal to about 10 wt. % to less than or equal to about 95 wt. %, and in certain aspects, optionally greater than or equal to about 50 wt. % to less than or equal to about 90 wt. %, of the positive solid-state electroactive particles 28 and greater than 0 wt. % to less than or equal to about 70 wt. %, and in certain aspects, optionally greater than or equal to about 10 wt. % to less than or equal to about 30 wt. %, of the adjunct electrolyte 30. Such positive electrodes 26 may have an interparticle porosity 44 between the positive solid-state electroactive particles 28 and/or the adjunct electrolyte 30 that is greater than or equal to about 1 vol. % to less than or equal to about 20 vol. %, and optionally greater than or equal to 5 vol. % to less than or equal to about 10 vol. %.

In various aspects, the positive electrode 26 may be one of a layered-oxide cathode, a spinel cathode, and a polyanion cathode. For example, in the instances of a layered-oxide cathode (e.g., rock salt layered oxides), the positive solid-state electroactive particles 28 may comprise one or more positive electroactive materials selected from LiCoO₂, LiNiₓMn_{y}Co_{1-x-y}O₂ (where 0≤x≤1 and 0≤y≤1), LiNiₓMn₁₋ₓO₂ (where 0≤x≤1), LiNiₓCo_{y}Al_{1-x-y}O₂ (where 0≤x≤1) and Li₁₊ₓMO₂ (where 0≤x≤1) for solid-state lithium-ion batteries. The spinel cathode may include one or more positive electroactive materials, such as LiMn₂O₄ and LiNiₓMn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. In this fashion, in various aspects, the positive solid-state electroactive particles 28 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNi_{0.5}Mn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 28 may be coated (for example, by Al₂O₃ or LiNbO₃) and/or the positive electroactive material may be doped (for example, by magnesium).

In certain variations, the positive solid-state electroactive particles 28 may be optionally intermingled with one or more electrically conductive materials that provide an electron conduction path and/or at least one polymeric binder material that improves the structural integrity of the positive electrode 26. For example, the positive solid-state electroactive particles 28 may be optionally intermingled with binders, like polyvinylidene difluoride (PVDF), sodium carboxymethyl cellulose (CMC), polytetrafluoroethylene (PTFE), ethylene propylene diene monomer (EPDM) rubber, nitrile butadiene rubber (NBR), styrene-butadiene rubber (SBR), styrene ethylene butylene styrene copolymer (SEBS), styrene butadiene styrene copolymer (SBS), and/or lithium polyacrylate (LiPAA) binders. Electrically conductive materials may include, for example, carbon-based materials, powdered nickel or other metal particles, or a conductive polymer. Carbon-based materials may include, for example, particles of graphite, graphene, graphene oxide, carbon black (e.g., Super P® carbon black (TIMCAL), acetylene black (such as KETCHEN™ black or DENKA™ black), carbon fibers (e.g., carbon nanofibers), carbon nanotubes, and the like. Examples of a conductive polymer may include polyaniline, polythiophene, polyacetylene, polypyrrole, and the like.

In certain aspects, mixtures of the conductive materials may be used. For example, the positive electrode 26 may include greater than or equal to about 0 wt. % to less than or equal to about 25 wt. %, optionally greater than or equal to about 0 wt. % to less than or equal to about 10 wt. %, and in certain aspects, optionally greater than or equal to about 0 wt. % to less than or equal to about 5 wt. % of the one or more electrically conductive additives and greater than or equal to about 0 wt. % to less than or equal to about 20 wt. %, optionally greater than or equal to about 0 wt. % to less than or equal to about 10 wt. %, and in certain aspects, optionally greater than or equal to about 0 wt. % to less than or equal to about 5 wt. % of the one or more binders. The positive electrode current collector 40 may be formed from aluminum or any other electrically conductive material known to those of skill in the art.

With reference to FIG. 2, the current technology also considers a solid state battery 20b that cycles lithium ions. The components of the solid state battery 20b having equivalent corresponding components in the battery 20a of FIG. 1 are labeled with the same numerals. As such, the secondary battery 20b comprises the negative electrode 22, the negative electrode current collector 38, the positive electrode 26, and the positive electrode current collector 40 and the electroactive particles 24,28 and adjunct electrolytes 30,32,34. However, in place of a separator, the solid state battery 20b includes a solid-state electrolyte 46 disposed between the electrodes 22, 26. The solid-state electrolyte 46 is both a separator that physically separates the negative electrode 22 from the positive electrode 26 and an ion-conducting electrolyte. The solid-state electrolyte 46 also provides a minimal resistance path for internal passage of ions. The solid-state electrolyte 46 comprises the solid-state electrolyte particles 34 described above and are in contact with the electrolyte composition 100 as a liquid or a gel. For example, the solid-state electrolyte 46 may be in the form of a layer or a composite that comprises the solid-state electrolyte particles 34 and that has a thickness greater than or equal to about 1 μm to less than or equal to about 1 mm, and in certain aspects, optionally greater than or equal to about 1 μm to less than or equal to about 100 μm. The solid-state electrolyte 46 may have an interparticle porosity 48 (defined herein as a fraction of the total volume of pores over the total volume of the layer or film being described) between the solid-state electrolyte particles 34 that is greater than 0 vol. % to less than or equal to about 50 vol. %, greater than or equal to about 1 vol. % to less than or equal to about 40 vol. %, or greater than or equal to about 2 vol. % to less than or equal to about 20 vol. %. As a result of the interparticle porosity 42,44,48 between particles within the battery 20b, direct contact between the solid-state electroactive particles 24,28 and the solid-state electrolyte particles 34 may be much lower than the contact between a liquid electrolyte and solid-state electroactive particles in comparable non-solid-state batteries. To improve contact between the solid-state electroactive particles 24,28 and solid-state electrolyte particles 34, the amount of the solid-state electrolyte particles 34 may be increased within the electrodes by including and/or introducing the adjunct electrolyte 30,32,34.

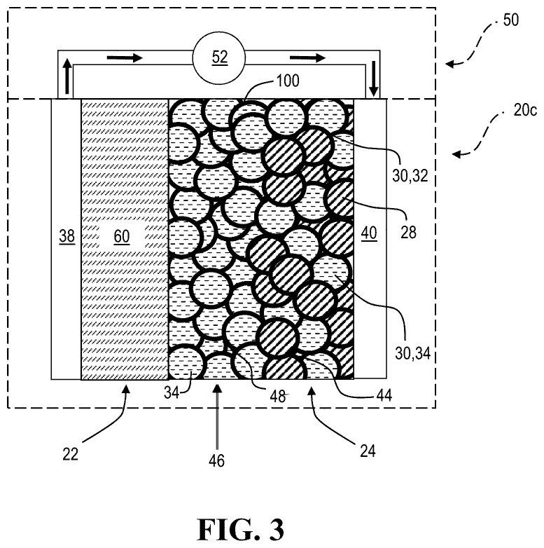

With reference to FIG. 3, the current technology also considers an all-solid-state metal battery 20c that cycles lithium ions. The components of the solid state battery 20c having equivalent corresponding components in the battery 20a of FIG. 1 and the solid-state battery 20b of FIG. 2 are labeled with the same numerals. As such, the secondary battery 20b comprises the negative electrode current collector 38, the positive electrode 26, and the positive electrode current collector 40, the positive electroactive particles 28, the cathode adjunct electrolyte 30,32,34, and the solid state electrolyte 46 in contact with the electrolyte composition 100. However, the negative electrode 22 of the all-solid-state metal battery 20c comprises a solid film 60 of lithium metal. Therefore, the negative electrode 22 does not comprise the negative electroactive particles 24. During cycling, ions, which are also produced at the negative electrode 22, are transferred between the solid film 60 of the negative electrode 22 and the positive electrode 26.

In accordance with the current technology, and with reference to FIG. 4, the electrolyte composition 100 comprises a solvate ionic liquid having an anion 102 and a complex 104 comprising an ether 106 and a cation 108; and a diluter 110. The electrolyte composition exhibits an ionic conductivity of greater than or equal to about 2 mS/cm, greater than or equal to about 2.5 mS/cm, greater than or equal to about 3 mS/cm, greater than or equal to about 3.5 mS/cm, greater than or equal to about 4 mS/cm, greater than or equal to about 4.5 mS/cm, greater than or equal to about 5 mS/cm, greater than or equal to about 5.5 mS/cm, or greater than or equal to about 6 mS/cm, and is non-flammable. When the electrolyte composition is included in the electrochemical cell 20a as a liquid electrolyte, the electrochemical cell 20a exhibits a capacity retention of greater than or equal to about 95% after 100 cycles of charging and discharging. As a liquid, the electrolyte composition 100 has a viscosity of greater than or equal to about 1 mPa·s to less than or equal to about 200 mPa·s, greater than or equal to about 1 mPa·s to less than or equal to about 100 mPa·s greater than or equal to about 1 mPa·s to less than or equal to about 50 mPa·s, or greater than or equal to about 1 mPa·s to less than or equal to about 20 mPa·s.

The anion 102 of the solvate ionic liquid is derived from a salt comprising the cation 108 and the anion 102. As non-limiting examples, the anion can be bis(fluorosulfonyl)imide (FSI⁻), bis(trifluoromethanesulfonyl)imide (TFSI⁻), bis(pentafluoroethanesulfonyl)imide (BETI⁻), hexafluorophosphate (PF₆⁻), tetrafluoroborate (BF₄⁻), trifluoromethyl sulfonate (TfO⁻), difluoroborate (DFOB⁻), bis(oxalate)borate (BOB⁻), or a combination thereof.

The ether 106 of the complex 104 comprises at least one or at least two ether oxygen atoms that are individually or collectively capable of solvating, i.e., chelating, the cation 108. In certain aspects, the ether 106 is an oligoether, such as a glyme (i.e., an ether of a glycol), having the formula CH₃O—(CH₂CH₂O)ₙ—CH₃, where 1≤n≤10. Non-limiting examples of the glyme include ethylene glycol dimethyl ether (G1; “monoglyme”), diethylene glycol dimethyl ether (G2; “diglyme”), triethylene glycol dimethyl ether (G3; “triglyme”), tetraethylene glycol dimethyl ether (G4; “tetraglyme”), pentaethylene glycol dimethyl ether (G5; “pentaglyme”), and combinations thereof. The cation 108 corresponds to the cations being cycled in the electrochemical cell 20a,20b,20c, which can be lithium cations (Li⁺) or sodium cations (Na⁺).

The solvate ionic liquid of the electrolyte composition 100 is characterized by an anion 102:complex 104 molar ratio of from about 0.5:1 to about 1:0.5, but preferably about 1:1. As such, there are substantially equimolar concentrations of the anion 102 and the complex 104, and by extension, equimolar concentrations of the anion 102, cation 108, and the ether 106. By substantially equimolar, it is meant that when the anion 102 and the complex 104 are not present in exactly equimolar concentrations, less than or equal to about 10% or less than or equal to about 5% of the anions 102 or complexes 104 are unpaired. Accordingly, the solvate ionic liquid can be substantially free of unpaired anions 102, or complexes 104. When the electrolyte composition 100 includes a combination of ethers 106 and/or anions 102, their respective total concentrations are included when determining the anion 102:complex 104 molar ratio.

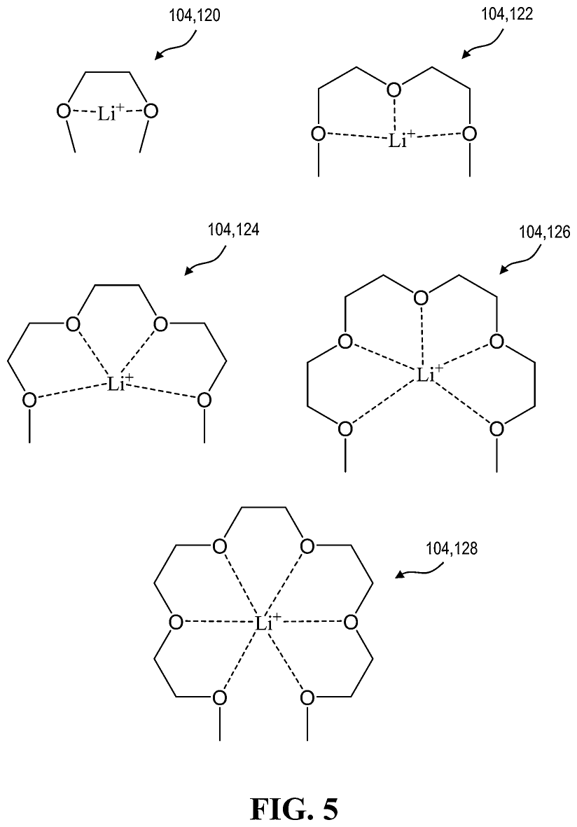

The solvate ionic liquid forms when a salt including the cation 108 and anion 102 is combined with the ether 106 as a solvent. Non-limiting examples of suitable salts include lithium bis(fluorosulfonyl)imide (LIFSI), lithium bis(trifluoromethanesulfonyl)imide (LiTFSI), lithium bis(pentafluoroethanesulfonyl)imide (LiBETI), lithium hexafluorophosphate (LiPF₆), lithium tetrafluoroborate (LiBF₄), lithium trifluoromethyl sulfonate (LiTfO), lithium difluoroborate (LiDFOB), lithium bis(oxalate)borate (LiBOB), and combinations thereof. When combined, lone pairs of electrons on the ether oxygen atoms act as Lewis bases, whereby the electrons are donated to the corresponding Lewis acid, i.e., the cation 108. As a result, the cation 108 is solvated (i.e., chelated) by the ether 106, and the complex 104 is formed. The complex 104 pairs with the anion 102. FIG. 5 shows non-limiting exemplary complexes 104 wherein the cations 108 are all Li⁺ and the anions 102 are monoglyme 120, diglyme 122, triglyme 124, tetraglyme 126, and pentaglyme 128. Therefore, the electrolyte composition 100 can include at least one complex 104 (i.e., can include one ether 106 or a plurality of different ethers 106 complexed with the cation 108) and at least one anion 102 (i.e., one anion 102 or a plurality of different anions 102). In certain aspects, the complex comprises, consists of, or consists essentially of monoglyme as the ether 106 (e.g., the complex 104,120). In certain aspects, the complex comprises, consists of, or consists essentially of diglyme as the ether 106 (e.g., the complex 104,122). In certain aspects, the complex comprises, consists of, or consists essentially of triglyme as the ether 106 (e.g., the complex 104,124). In certain aspects, the complex comprises, consists of, or consists essentially of tetraglyme as the ether 106 (e.g., the complex 104,126). In certain aspects, the complex comprises, consists of, or consists essentially of pentaglyme as the ether 106 (e.g., the complex 104,128). As used herein, the term “consists essentially of” means that that no other components are intentionally included, but may be present as unavoidable impurities at concentrations of less than or equal to about 5 wt. % based on the total weight of the element being described (e.g., the ether 106).

Referring back to FIG. 4, the diluter 110 is a phosphorus-containing flame retardant that provides the non-flammable properties and that dilutes the concentration of the solvate ionic liquid in the electrolyte composition, such that as the concentration of the diluter 110 increases in the electrolyte composition 100, the concentration of the solvate ionic liquid decreases. Accordingly, the solvate ionic liquid and the diluter 110 are present in the electrolyte composition 100 in a solvate ionic liquid:diluter ratio of from about 1:10 to about 5:1 or from about 0.5:1 to about 1:1, by volume. In certain aspects, the diluter 110 is added to the solvate ionic liquid to provide a Li⁺ concentration of greater than or equal to about 0.5 M to less than or equal to about 2 M, or greater than or equal to about 0.8 M to less than or equal to about 1.2 M. As a non-limiting example, the solvate ionic liquid Li(G3)TFSI has a concentration of 3.06 M, which can be decreased to, e.g., 1.2 M by adding the diluter 110.

The phosphorus-containing flame retardant diluter 110 is at least one of a phosphate, a phosphite, or a phosphonate having a dielectric constant of less than or equal to about 20. Non-limiting examples of the phosphate include triethyl phosphate, trimethyl phosphate, tributyl phosphate, triphenyl phosphate, phosphazene, diphenyloctyl phosphate, tris(2,2,2-trifluoroethyl)phosphate, and combinations thereof. Non-limiting examples of the phosphite include triethyl phosphite, trimethyl phosphite, tributyl phosphite, triphenyl phosphite, and combinations thereof. Non-limiting examples of the phosphonate include bis(2,2,2-trifluoroethyl) methyl phosphonate, diethyl phosphonate, diethyl ethyl phosphonate, and combinations thereof.

In some aspects, the electrolyte composition 100 can further include a solid electrolyte interface (SEI) additive that is suitable to help form, for example, a solid electrolyte interface on an anode, including the anode 22 of the electrochemical cells 20a,20b, 20c of FIGS. 1-3. As non-limiting examples, the SEI additive can be vinylene carbonate (VC), fluoroethylene carbonate (FEC), vinylethylene carbonate (VEC), butylene carbonate (BC), ethylene sulfite (ES), propylene sulfite (PS), lithium tetrafluoroborate (LiBF₄), lithium difluoroborate (LiDFOB), lithium bis(oxalate)borate (LiBOB), or combinations thereof. The SEI additive can be included in the electrolyte composition 100 at a concentration of greater than or equal to about 0.5 wt. % to less than or equal to about 10 wt. %, or greater than or equal to about 0.5 wt. % to less than or equal to about 5 wt. % based on the total weight of the electrolyte composition 100%.

In various aspects, the electrolyte composition 100 is substantially free of solvents that are not solvate ionic liquids, such as aqueous and inorganic solvents and non-solvate ionic liquid organic solvents. By “substantially free” it is meant no other non-solvate ionic liquid solvents are only present as unavoidable impurities at a concentration of less than or equal to about 5 wt. % based on the total weight of the electrolyte composition 100. Accordingly, a liquid component of the electrolyte composition 100, i.e., the solvents, may comprise, consist essentially of, or consist of at least one solvate-ionic liquid (as described herein) and at least one diluter 110. Also, the electrolyte composition 100 may comprise, consist essentially of, or consist of at least one solvate-ionic liquid (as described herein), at least one diluter 110, and optionally at least one SEI additive. As used herein, the term “consists essentially of” means that that no other components are intentionally included, but may be present as unavoidable impurities at concentrations of less than or equal to about 5 wt. % based on the total weight of the element being described (e.g., the solvent or the electrolyte composition 100).

The electrolyte composition 100, as a liquid, can be at least one of: (1) the electrolyte of the electrochemical cell 20a shown in FIG. 1; (2) the liquid adjunct electrolyte 32 (anolyte) contacting or coating the negative electroactive particles 24 of the electrochemical cells 20a,20b of FIGS. 1 and 2; (3) the liquid adjunct electrolyte 32 contacting or coating the positive electroactive particles 28 (catholyte) of the electrochemical cells 20a,20b,20c of FIGS. 1-3; (4) the electrolyte composition 100 contacting or coating the solid-state particles 34 of the adjunct electrolyte 30 in the electrochemical cells 20a,20b,20c of FIGS. 1-3; or (5) the electrolyte composition 100 contacting or coating the solid-state particles 34 of the solid-state electrolyte 46 of the electrochemical cells 20b,20c of FIGS. 2-3.

As shown in FIG. 6, the current technology also provides the electrolyte composition 100 in the form of an electrolyte gel 150 in which the electrolyte composition 100, including the solvate ionic liquid, diluter and optional SEI additive, embedded within a polymeric matrix 152 comprising a polymer. The polymeric matrix 152 can define a gel membrane having a first surface 154 and an opposing second surface 152. All of the properties of the electrolyte composition 100, except for the viscosity, are retained in the electrolyte gel 150.

The electrolyte get 150 includes the polymer at a concentration of greater than 0 wt. % to less than or equal to about 50 wt. %, greater than 0 wt. % to less than or equal to about 20 wt. % based on the total weight of the electrolyte gel, or greater than 0 wt. % to less than or equal to about 15 wt. % based on the total weight of the electrolyte gel. As non-limiting examples, the polymer can be polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), or combinations thereof. As a non-limiting example, FIG. 7 shows a gel membrane including 10 wt. % PVDF-HFP.

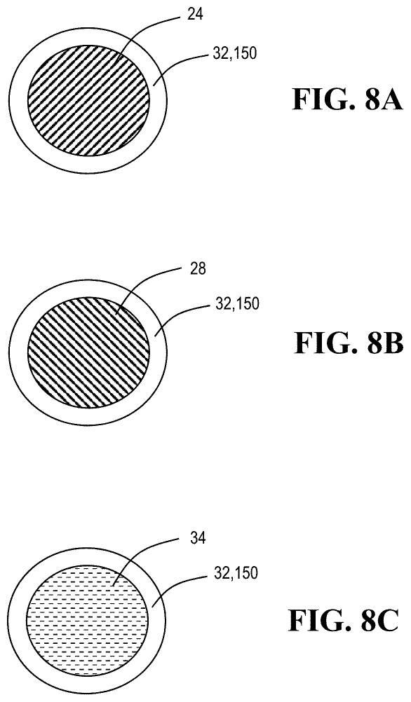

The electrolyte gel 150 can be used as the separator 36 of the electrochemical cell 20a shown in FIG. 1 or the electrolyte gel 150 can be a gel adjunct electrolyte coating electroactive particles. For example, FIG. 8A shows one of the negative electroactive particles 24 coated with the gel adjunct electrolyte 32 (anolyte) of the electrochemical cells 20a,20b of FIGS. 1 and 2, wherein the gel adjunct electrolyte 32 is the electrolyte gel 150. FIG. 8B shows one of the positive electroactive particles 28 coated with the gel adjunct electrolyte 32 (catholyte) of the electrochemical cells 20a,20b,20c of FIGS. 1-3, wherein the gel adjunct electrolyte 32 is the electrolyte gel 150. FIG. 8C shows one of the solid-state particles 34 of the adjunct electrolyte 30 in the electrochemical cells 20a,20b,20c of FIGS. 1-3 or of the solid-state electrolyte 46 of the electrochemical cells 20b,20c of FIGS. 2-3. Thus, at least a portion (include some or all) of the electroactive particles 24,28 and/or of the solid-state particles 34 can be coated with the electrolyte gel 150 in each of the electrochemical cells 20a,20b,20c.

The current technology also provides a method for preparing the electrolyte gel 150. The method includes forming a precursor solution by combining a lithium salt (such as those discussed above), an ether (i.e., the ether 106), a diluter (i.e., the diluter 110), and optionally an SEI additive with an ether (i.e., the ether 106) and a sacrificial solvent. In certain aspects, the sacrificial solvent is an aprotic solvent (polar or nonpolar) having a low boiling point, e.g., below about 150° C., such as dimethyl carbonate (DMC), tetrahydrofuran (THF), dichloromethane, ethyl acetate, acetone, N,N-dimethylformamide (DMF), acetonitrile (MeCN), dimethyl sulfoxide (DMSO), or combinations thereof as non-limiting examples. The lithium salt, ether, diluter, and optional SEI additive are included in the concentrations and/or ratios discussed herein. The sacrificial solvent is included at weight ratio of greater than or equal to about 100 wt. % to less than or equal to about 300 wt. % based on the total weight of the precursor solution. The method then comprises casting the precursor solution on a substrate, such as a temporary flat surface, an electrode (e.g., the negative and/or positive electrodes 22,26 of FIGS. 1-3), a solid-state electrolyte (e.g., the solid state electrolyte 46 of FIGS. 2-3), electroactive particles (e.g., the electroactive particles 24,28 of FIGS. 1-3), or solid-state electrolyte particles (e.g., the solid-state electrolyte particles 34 of FIGS. 1-3). The casting can be performed by any method known in the art, including by dripping, pouring, pipetting, doctor blading, spin casting, dunking (i.e., submerging), and the like. The method then comprises removing the sacrificial solvent to form the electrolyte gel 150, for example, by evaporating the sacrificial solvent. The evaporating can be facilitated by heating to a temperature greater than or equal to about 25° C. to less than or equal to about 150° C., with the proviso that the temperature is lower than the boiling points of the diluter and the ether. Where the substrate is the temporary flat surface, the electrolyte gel 150 can be removed and isolated form the surface.

The current technology also provides a method of fabricating an electrochemical cell, such as the electrochemical cells 20a,20b,20c of FIGS. 1-3. The method comprises contacting the electrolyte composition 100 described above, as a liquid or as the electrolyte gel 150, to at least one of a positive electrode, a negative electrode, a polymeric separator, or a solid-state electrolyte. When the electrolyte composition 100 is the liquid, the contacting can be performed by any method known in the art, including by dripping, pouring, pipetting, doctor blading, spin casting, dunking (i.e., submerging), and the like. The electrochemical cell can then be assembled. Alternatively, the electrochemical cell is preassembled, and the liquid electrolyte composition 100 is transferred to the electrochemical cell as the electrolyte. When the electrolyte composition is the electrolyte gel 150, the contracting can be performed in accordance with the above-described method for preparing the electrolyte gel 150 or by assembling the electrolyte gel 150 into the electrochemical cell, for example, as the separator.

Embodiments of the present technology are further illustrated through the following non-limiting example.

### Example

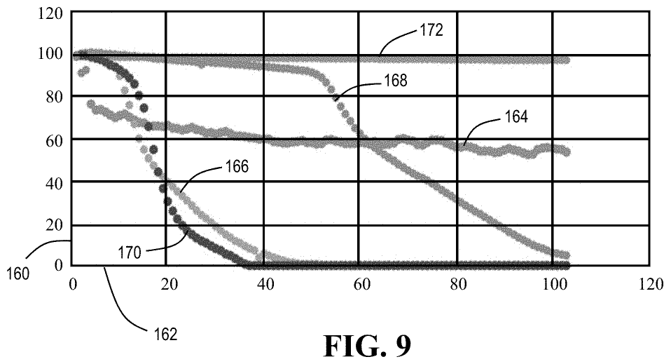

A solvate ionic liquid is prepared by combining LiTFSI with triglyme (G3) in a molar ratio of about 1:1 to form a solvate ionic liquid (Li(G3)TFSI). Electrolyte samples are prepared by diluting the solvate ionic liquid with a series of diluters to result in a lithium ion centration of about 1.2 M. The diluters are dimethyl carbonate (having a dielectric constant of 3.1), acetonitrile (having a dielectric constant of 37.5), ethyl acetate (having a dielectric constant of 6), and triethyl phosphate (having a dielectric constant of 13.01, and in accordance with the current technology). Electrochemical cells having a lithium manganese oxide (LMO) positive electrode (cathode), a lithium titanium oxide (LTO) negative electrode (anode), a separator including PP and PE (Celgard), and one of the electrolyte samples, are assembled. The electrochemical cells are subjected to about 100 charge/discharge cycles at 1 C and examined to determine their respective capacity retention. The results are shown in FIG. 9, which is a graph having a y-axis 160 representing capacity retention (%) and an x-axis 162 representing cycle number. A baseline curve 164 (control) represents a the Li(G3)TFSI without a diluter. A first curve 166 represents the electrochemical cell having the dimethyl carbonate diluter in the Li(G3)TFSI electrolyte, a second curve 168 represents the electrochemical cell having the acetonitrile diluter in the Li(G3)TFSI electrolyte, a third curve 170 represents the electrochemical cell having the ethyl acetate diluter in the Li(G3)TFSI electrolyte, and a fourth curve 172 represents the electrochemical cell having the triethyl phosphate diluter in the Li(G3)TFSI electrolyte (according to the current technology). The fourth curve 172 indicates that the electrolyte according to the current technology retained greater than 95% of its initial capacity after about 100 cycles.

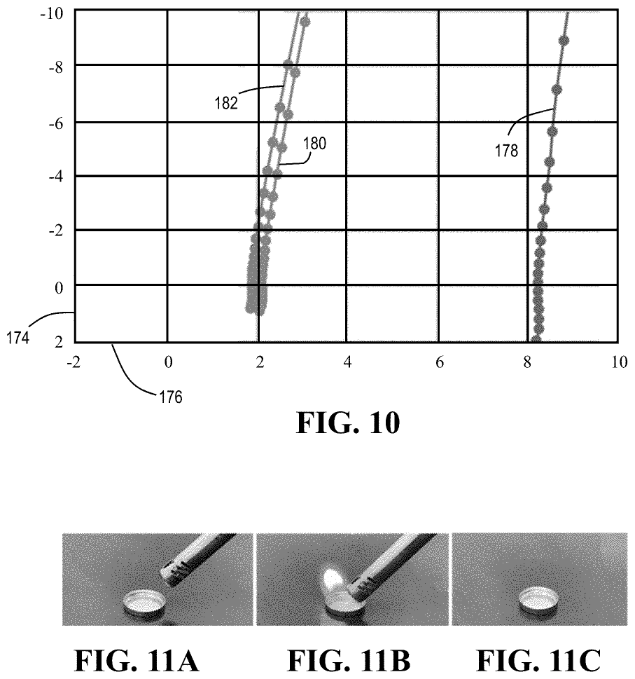

A solvate ionic liquid is prepared by combining LiTFSI with triglyme (G3) in a molar ratio of about 1:1 to form a solvate ionic liquid (Li(G3)TFSI). Electrolyte samples are prepared by diluting the solvate ionic liquid with triethyl phosphate to result in a first sample having a lithium ion concentration of about 1.2 M and a second sample having a lithium ion concentration of about 1 M. A baseline control includes the Li(G3)TFSI without a diluter. Electrochemical cells having a lithium manganese oxide (LMO) positive electrode (cathode), a lithium titanium oxide (LTO) negative electrode (anode), a separator including PP and PE (Celgard), and one of the electrolyte samples, are assembled. The electrochemical cells are analyzed by electrochemical impedance spectroscopy (EIS). FIG. 10 is a Nyquist plot obtained from the EIS at 25° C. The Nyquist plot has a y-axis 174 representing an imaginary part of the impedance ((Z″)/Ω) and an x-axis 176 representing a real part of the impedance ((Z′)/Ω). The Nyquist plot includes a first curve 178 representing the electrochemical cell having the baseline control electrolyte without a diluter (exhibiting an impedance of 8.22Ω and an ionic conductivity of 1.48 mS/cm), a second curve 180 representing the electrochemical cell having 1.2 M Li⁺ in the Li(G3)TFSI diluted with triethyl phosphate (sample 2; exhibiting an impedance of 2.06Ω and an ionic conductivity of 5.91 mS/cm), and a third curve 182 representing the electrochemical cell having 1 M Li⁺ in the Li(G3)TFSI diluted with triethyl phosphate (sample 3; exhibiting an impedance of 1.9Ω and an ionic conductivity of 6.41 mS/cm). The Nyquist plot demonstrates that ionic conductivity increases as the triethyl phosphate concentration increases (and the Li⁺ concentration decreases).

FIGS. 11A, 11B, and 11C are photographs of the electrolyte composition having Li(G3)TFSI diluted with triethyl phosphate to a final Li⁺ concentration of 1.2 M, before contact with a flame, during 30 seconds of contact with a flame, and immediately after the 30 seconds of contact with the flame, respectively. These photographs show that the electrolyte composition is non-flammable due to the flame retardant triethyl phosphate (TEP).

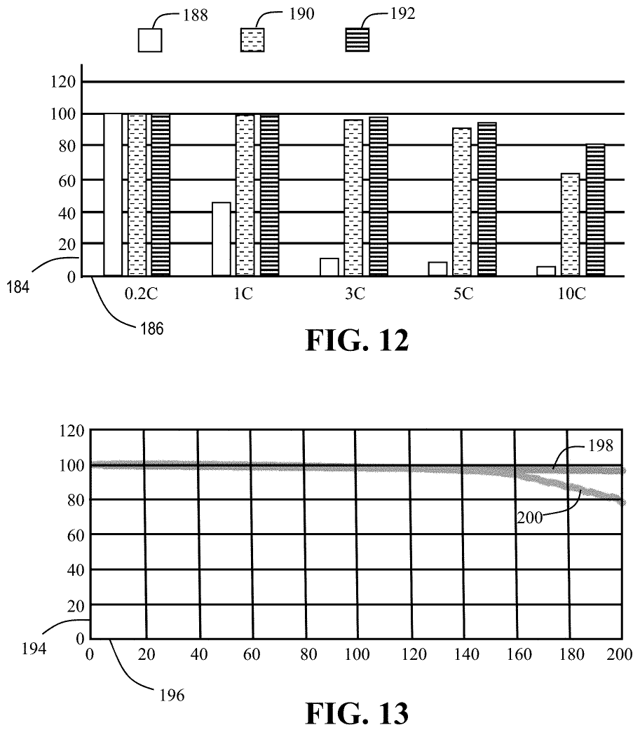

The baseline control electrolyte (undiluted Li(G3)TFSI), sample 1 (Li(G3)TFSI-TEP, 1.2 M Li⁺), and sample 2 (Li(G3)TFSI-TEP, 1 M Li⁺) are subjected to charge/discharge cycles and examined to determine their respective capacity retention. The results are shown in FIG. 12, which is a bar graph having a y-axis 184 representing capacity retention (%) and an x-axis 186 representing C-rate (C). Bars 188 correspond to the electrochemical cell having the baseline control electrolyte, bars 190 correspond to the electrochemical cell having the sample 1 electrolyte (Li(G3)TFSI-TEP, 1.2 M Li⁺), and bars 192 correspond to the electrochemical cell having the sample 2 electrolyte (Li(G3)TFSI-TEP, 1 M Li⁺). The results shown in the graph demonstrate that the diluter TEP improves the capacity retention (rate capability) in both samples 1 and 2 relative to the electrochemical cell having the baseline control electrolyte. At 5 C and 10 C, the sample 2 electrolyte had a slightly improved capacity retention (rate capability) relative to the sample 1 electrolyte.

The cycling performance of the electrochemical cells having the sample 1 and sample 2 electrolytes was also determined over 200 charge/discharge cycles at 1 C. The results are shown in FIG. 13, which is a graph having a y-axis 194 representing capacity retention (%) and an x-axis 196 representing cycle number. A first curve 198 corresponds to the electrochemical cell having the sample 1 electrolyte (Li(G3)TFSI-TEP, 1.2 M Li⁺), and a second curve 200 correspond to the electrochemical cell having the sample 2 electrolyte (Li(G3)TFSI-TEP, 1 M Li⁺). The results shown in the graph demonstrate that the electrochemical cell having the sample 1 electrolyte (Li(G3)TFSI-TEP, 1.2 M Li⁺) retains greater than 95% of its original capacity after 200 cycles. The capacity retention of the electrochemical cell having the sample 2 electrolyte (Li(G3)TFSI-TEP, 1 M Li⁺) slightly decreases after about 160 cycles.

The results shown in FIGS. 12 and 13 demonstrate that a balance is struck between discharge power and cycling performance as the concentration of the diluter increases in the electrolyte composition of the current technology.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An electrolyte composition comprising:
a solvate ionic liquid having an anion and a complex comprising an ether and a cation; and
a diluter comprising a phosphorus-containing flame-retardant having a dielectric constant of less than or equal to about 20.

2. The electrolyte composition according to claim 1, wherein the anion of the solvate ionic liquid is selected from the group consisting of bis(trifluoromethanesulfonyl)imide (TFSI⁻), bis(pentafluoroethanesulfonyl)imide (BETI⁻), hexafluorophosphate (PF₆⁻), tetrafluoroborate (BF₄⁻), trifluoromethyl sulfonate (TfO⁻), difluoroborate (DFOB⁻), bis(oxalate)borate (BOB⁻), and a combination thereof.

3. The electrolyte composition according to claim 1, wherein the ether is an oligoether having the formula CH₃O—(CH₂CH₂O)ₙ—CH₃, where 1≤n≤10 and the cation is Li⁺.

4. The electrolyte composition according to claim 1, wherein the diluter comprises a phosphate flame-retardant selected from the group consisting of triethyl phosphate, trimethyl phosphate, tributyl phosphate, triphenyl phosphate, phosphazene, diphenyloctyl phosphate, tris(2, 2, 2-trifluoroethyl)phosphate, and a combination thereof.

5. The electrolyte composition according to claim 1, wherein the diluter comprises a phosphite flame-retardant selected from the group consisting of triethyl phosphite, trimethyl phosphite, tributyl phosphite, triphenyl phosphite, and a combination thereof.

6. The electrolyte composition according to claim 1, wherein the diluter comprises a phosphonate flame-retardant selected from the group consisting of bis(2.2.2.-trifluoroethyl) methyl phosphonate, diethyl phosphonate, diethyl ethyl phosphonate, and a combination thereof.

7. The electrolyte composition according to claim 1, wherein the solvate ionic liquid and the diluter are present in a solvate ionic liquid:diluter ratio of from about 1:10 to about 5:1 by volume.

8. The electrolyte composition according to claim 1, wherein the solvate ionic liquid comprises an anion:complex molar ratio of about 1:1.

9. The electrolyte composition according to claim 1, further comprising:
a solid electrolyte interface additive.

10. The electrolyte composition according to claim 1, wherein the electrolyte composition is substantially free of solvents that are not ionic liquids or solvate ionic liquids.

11. The electrolyte composition according to claim 1, wherein the solvate ionic liquid and diluter are embedded within a polymer, the polymer having a concentration of greater than 0 wt. % to less than or equal to about 50 wt. % based on the total weight of the solvate ionic liquid and the polymer, and wherein the electrolyte composition is a gel electrolyte.

12. An electrochemical cell comprising the electrolyte composition according to claim 1.

13. An electrochemical cell comprising:
a positive electrode comprising positive electroactive particles;
a negative electrode comprising negative electroactive particles; and
and an electrolyte composition comprising:
a solvate ionic liquid having an anion and a glyme-lithium cation complex in an anion:glyme-lithium cation complex molar ratio of about 1:1, and
a diluter comprising a phosphorus-containing flame-retardant having a dielectric constant of less than or equal to about 20,
wherein the solvate ionic liquid and the diluter are present in a solvate ionic liquid:diluter volumetric ratio of from about 1:10 to about 5:1, and
wherein the electrolyte composition is non-flammable,
wherein the electrochemical cell exhibits a capacity retention of greater than or equal to about 95% after 100 cycles of charging and discharging.

14. The electrochemical cell according to claim 13, wherein the anion of the solvate ionic liquid is bis(trifluoromethanesulfonyl)imide (TFSI⁻), bis(pentafluoroethanesulfonyl)imide (BETI⁻), hexafluorophosphate (PF₆⁻), tetrafluoroborate (BF₄⁻), trifluoromethyl sulfonate (TfO⁻), difluoroborate (DFOB⁻), bis(oxalate)borate (BOB⁻), or a combination thereof, and the glyme of the solvate ionic liquid is ethylene glycol dimethyl ether (G1), diethylene glycol dimethyl ether (G2), triethylene glycol dimethyl ether (G3), tetraethylene glycol dimethyl ether (G4), or a combination thereof.

15. The electrochemical cell according to claim 13, wherein the anion is bis(trifluoromethanesulfonyl)imide (TFSI⁻), the glyme comprises at least one of triethylene glycol dimethyl ether (G3) or tetraethylene glycol dimethyl ether (G4), and the diluter comprises triethyl phosphate.

16. The electrochemical cell according to claim 13, wherein the electrochemical cell further comprises a polymeric separator disposed between the positive electrode and the negative electrode, wherein the electrolyte composition is capable of transporting lithium ions between the positive electrode and the negative electrode, and wherein the electrolyte composition is a liquid or a gel comprising the solvate ionic liquid and the diluter embedded within a polymer matrix.

17. The electrochemical cell according to claim 13, wherein the electrochemical cell is a solid-state electrochemical cell further comprising a solid-state electrolyte disposed between the positive electrode and the negative electrode, wherein the electrolyte composition is in contact with at least a portion of the positive electroactive particles, the negative electroactive particles, the solid-state electrolyte, or a combination thereof, and wherein the electrolyte composition is a liquid or a gel comprising the solvate ionic liquid and the diluter embedded within a polymer matrix.

18. A method of fabricating an electrochemical cell, the method comprising:
contacting an electrolyte composition to at least one of a positive electrode, a negative electrode, or one of a polymeric separator or a solid-state electrolyte,
wherein the electrolyte composition comprises:
a solvate ionic liquid having an anion and a complex comprising an ether and a cation; and
a diluter comprising a phosphorus-containing flame-retardant having a dielectric constant of less than or equal to about 20.

19. The method according to claim 18, wherein the electrolyte composition is a liquid or a gel comprising the solvate ionic liquid and the diluter embedded within a polymer matrix.

20. The method according to claim 18, wherein the anion of the solvate ionic liquid is bis(trifluoromethanesulfonyl)imide (TFSI⁻), bis(pentafluoroethanesulfonyl)imide (BETI⁻), hexafluorophosphate (PF₆⁻), tetrafluoroborate (BF₄⁻), trifluoromethyl sulfonate (TfO⁻), difluoroborate (DFOB⁻), bis(oxalate)borate (BOB⁻), or a combination thereof; the glyme of the solvate ionic liquid is ethylene glycol dimethyl ether (G1), diethylene glycol dimethyl ether (G2), triethylene glycol dimethyl ether (G3), tetraethylene glycol dimethyl ether (G4), or a combination thereof; and the cation is lithium cation.
